(19) United States
(12) Patent Application Publication
(10) Pub. No.: US 2024/0354364 A1
(43) Pub. Date: Oct. 24, 2024

(54) CALCULATION MODEL, INFORMATION PROCESSING METHOD, STORAGE MEDIUM, AND INFORMATION PROCESSING DEVICE

(71) Applicant: TDK CORPORATION, Tokyo (JP)

(72) Inventors: Kaito ASAI, Tokyo (JP); Tsuyoshi SUZUKI, Tokyo (JP)

(73) Assignee: TDK CORPORATION, Tokyo (JP)

(21) Appl. No.: 18/685,607

(22) PCT Filed: Aug. 27, 2021
(86) PCT No.: PCT/JP2021/031608

§ 371 Date: Feb. 22, 2024

(51) Int. Cl. G06F 17/11

(52) U.S. Cl. CPC G06F 17/11

(57) ABSTRACT

A calculation model is a calculation model applicable to an Ising model or QUBO and includes a plurality of expression bits and a first surplus bit, each of the; plurality of expression bits is a binary variable, the plurality of expression tits indicate options in a combinatorial optimization problem, and the first surplus bit is coupled to any one of the plurality of expression bits.

### TECHNICAL FIELD

The present invention relates to a calculation model, an information processing method, a calculation program, and an information processing device.

### BACKGROUND ART

Attempts have been made to obtain an optimal solution to a combinatorial optimization problem using quantum annealing (for example, Patent Document 1).

### CITATION LIST

### Non-Patent Document

### [Non-Patent Document 1]

International Publication No. 2020/196872

### SUMMARY OF INVENTION

### Technical Problem

In a quantum annealing machine, an error may occur due to an unintended quantum transition, noise, or the like, and an optimal solution may not be obtained appropriately.

The present invention has been made in view of the above circumstances, and an object of the present invention is to provide a calculation model, an information processing method, a calculation program, and an information processing device capable of detecting an error caused by noise or the like.

### Solution to Problem

The present invention provides the following means to solve the above problem.

(1) A calculation model according to a first aspect is a calculation model applicable to an Ising model or QUBO, the calculation model including: a plurality of expression bits and a first surplus bit, wherein each of the plurality of expression bits is a binary variable, the plurality of expression bits indicate options in a combinatorial optimization problem, and the first surplus bit is coupled to any one of the plurality of expression bits.

(2) The calculation model may include a plurality of the first surplus bits. Each of the first surplus bits is coupled to any one of the plurality of expression bits.

(3) The calculation model may further include a second surplus bit coupled to an expression bit coupled to the first surplus bit or the first surplus bit.

(4) In the calculation model, the plurality of expression bits may express the options in a one-hot expression.

(5) In the calculation model, the plurality of expression bits may express the options in a binary expression.

(6) In the calculation model, the Ising model or the QUBO may execute optimization calculation using a quantum annealing machine.

(7) An information processing method according to a second aspect is an information processing method using the calculation model. This information processing method includes comparing the first surplus bit with an expression bit coupled to the first surplus bit to detect an error.

(8) The information processing method according to the aspect is an information processing method using a calculation model, and includes comparing the first surplus bit with an expression bit coupled to the first surplus bit to detect an error; and correcting the error on the basis of values of the first surplus bit, the second surplus bit, and the expression bit.

(9) A calculation program according to a third aspect includes: a computing program configured to perform computing using the calculation model according to the aspect; and a detection program configured to compare the first surplus bit with the expression bit coupled to the first surplus bit to detect an error.

(10) The calculation program according to the aspect includes: a computing program configured to perform computing using the calculation model according to the aspect; a detection program configured to compare the first surplus bit with the expression bit coupled to the first surplus bit to detect an error; and a correction program configured to correct the error on the basis of values of the first surplus bit, the second surplus bit, and the expression bit.

(11) An information processing device according to a fourth aspect includes the calculation program according to the aspect.

### Advantageous Effects of Invention

The calculation model, information processing method, calculation program, and information processing device according to the present invention can detect an error caused by noise or the like.

### BRIEF DESCRIPTION OF DRAWINGS

FIG. 1 is an image diagram of an Ising model and QUBO.

FIG. 2 is an image diagram of a calculation model according to the present embodiment.

FIG. 3 illustrates an example of a case in which a one-hot expression of options in a combinatorial optimization problem has been performed by using a plurality of expression bits.

FIG. 4 illustrates an example of a case in which a binary expression of the options in the combinatorial optimization problem has been performed by using a plurality of expression bits.

FIG. 5 illustrates an example of a case in which the options, including first surplus bits and second surplus bits, are displayed in the case of the one-hot expression illustrated in FIG. 3.

FIG. 6 illustrates an example of a case in which the options, including first surplus bits and second surplus bits, are displayed in the case of the binary expression illustrated in FIG. 4.

FIG. 7 is a process flow diagram of an information processing method in the present embodiment.

FIG. 8 illustrates another example of the case in which the options, including the first surplus bits and the second surplus bits, have been displayed in the case of the binary expression illustrated in FIG. 4.

FIG. 9 illustrates a modification example of the calculation model according to the present embodiment.

FIG. 10 illustrates a modification example of the calculation model according to the present embodiment.

### DESCRIPTION OF EMBODIMENTS

Hereinafter, the present embodiment will be described in detail while appropriately referring to the drawings. In the drawings to be used in the following description, portions that are characteristics of the present embodiment may be enlarged and shown for convenience in order to make it easier to understand the characteristics, and dimensional ratios of respective components may be different from actual ones. Materials, dimensions, and the like illustrated in the following description are merely examples, and the present invention is not limited thereto and can be implemented with 20 appropriate change within the scope of the gist of the present invention.

### “First Embodiment”

A calculation model according to a first embodiment is an Ising model used for quantum annealing or a calculation model applicable to QUBO. The quantum 25 annealing is an algorithm for obtaining a state with minimum energy (ground state) according to the calculation model.

The Ising model is a model in which a plurality of elements interact and, when a forcing force is applied to each element, a stable state is predicted as a whole.

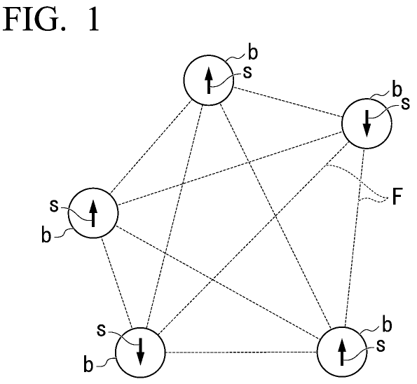

FIG. 1 is an image diagram of the Ising model. The Ising model has a plurality of bits b that interact with each other due to a forcing force F. Each bit b consists of a spin s. The spin s indicates either an upward state or a downward state. Each bit b is a variable indicating a binary state. For an adjacent spin s, a parallel state becomes a stable state or an antiparallel state becomes the stable state depending on the setting of the forcing force F. The forcing force F is said to be an interaction parameter.

The Ising model is expressed by the following energy function (cost function).

$$H = {\sum }_{i \neq j} {J}_{ij} {σ}_{i} {σ}_{j} + {\sum }_{i} {h}_{i} {σ}_{i} \qquad [ Math . 1 ]$$

Here, σᵢ denotes an input variable. σᵢ and σⱼ denote either +1 or −1. σᵢ and σⱼ correspond to states of the spin s in FIG. 1. Jᵢⱼ is an interaction parameter. Jᵢⱼcorresponds to the forcing force Fin FIG. 1. hᵢ is a parameter involved in an external factor.

Quadratic unconstrained binary optimization (QUBO) is a calculation model that can be equivalently converted to an Ising model. In the Ising model, each bit b is expressed by a binary variable of +1 or −1, whereas in QUBO, each bit b is expressed by a binary variable of 0 or 1. QUBO can be applied to the calculation model like the Ising model. The QUBO is expressed by the following energy function (cost function).

$$H = {\sum }_{i , j} {Q}_{ij} {q}_{i} {q}_{j} \qquad [ Math . 2 ]$$

Here, qᵢ and qⱼ denote input variables. qⁱ and qⱼ denote either a binary value 1 or 0. qᵢ and qⱼ correspond to a state of the spin s in the Ising model. Qᵢⱼ is an interaction parameter in QUBO. Qᵢⱼ corresponds to the forcing force F in the Ising model.

The Ising model and the QUBO can be applied to a combinatorial optimization problem.

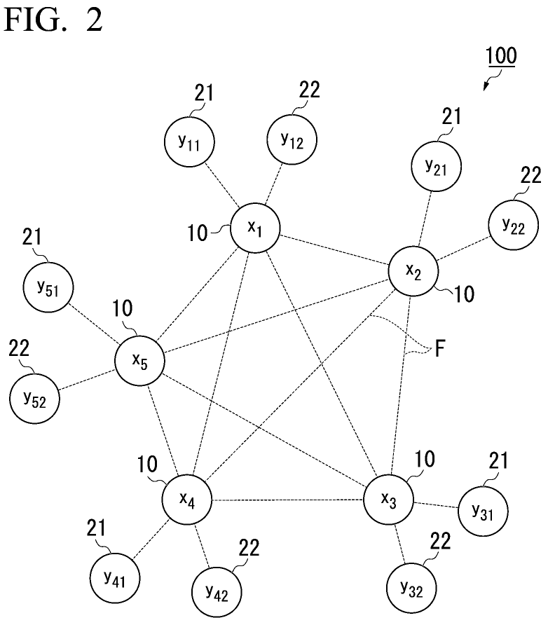

FIG. 2 is an image diagram of an example of a calculation model according to the present embodiment. The calculation model 100 according to the present embodiment includes a plurality of the expression bits 10, a plurality of first surplus bits 21, and a plurality of second surplus bits 22.

The expression bit 10, the first surplus bit 21, and the second surplus bit 22 correspond to respective bits b in FIG. 1. The expression bit 10, the first surplus bit 21, and the second surplus bit 22 are input variables σᵢ and σⱼ or input variables qᵢ and qⱼ in an energy function (cost function).

The expression bit 10, the first surplus bits 21, and the second surplus bits 22 are binary variables x₁ to x₅, y₁₁ to y₅₁, and y₁₂ to y₅₂, respectively. The variables x₁ to x₅, y₁₁ to y₅₁, and y₁₂ to y₅₂ each indicate, for example, 1 or 0. The variables x₁ to x₅, y₁₁ to y₅₁, and y₁₂ to y₅₂ may each indicate, for example, +1 or −1. The number of the expression bits 10, first surplus bits 21, and second surplus bits 22 does not matter.

The expression bit 10 is coupled to two or more bits. The expression bit 10 is coupled to other expression bits 10. A strength of the coupling between the expression bits 10 depends on a magnitude of the forcing force F.

The first surplus bit 21 is coupled to the expression bit 10. The first surplus bits 21 are, for example, coupled to the respective expression bits 10 one by one. The first surplus bit 21 illustrated in FIG. 2 is coupled only to the expression bit 10.

The second surplus bit 22 is coupled to the expression bit 10, for example. The second surplus bits 22 are, for example, coupled to the respective expression bits 10 one by one. The second surplus bit 22 illustrated in FIG. 2 is coupled only to the expression bit 10.

The plurality of expression bits 10 indicate respective options in the combinatorial optimization problem through a combination of respective values. The value of each expression bit 10 is a parameter indicating the option in the combinatorial optimization problem. The option in the combinatorial optimization problem is, for example, a route to a certain city in a certain order in the case of a traveling salesman problem.

The plurality of expression bits 10 may express the options in the combinatorial optimization problem in one-hot format, in binary format, or in a combination of the one-hot format and the binary format. The combination of the one-hot expression and the binary expression means expressing some of a plurality of options in the one-hot expression, and expressing the other options in the binary expression.

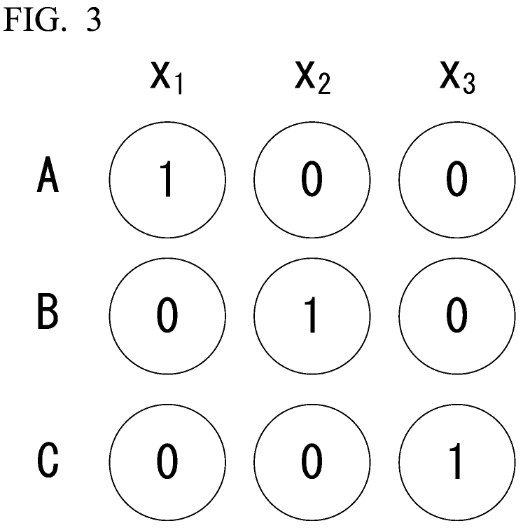

FIG. 3 illustrates an example of a case in which options are displayed in the one-hot expression. A, B, and C in FIG. 3 are options in the combinatorial optimization problem. In FIG. 3, each expression bit 10 indicates “1” or “0”.

The one-hot expression is a method of expressing N types of information using N expression bits 10. In the case of the one-hot expression, only one of the N expression bits 10 becomes “1” and all other bits become “0”. In FIG. 3, an option A is assigned to (1, 0, 0), an option B is assigned to (0, 1, 0), and an option C is assigned to (0, 0, 1).

Although an example in which the number of options is three has been shown here, it is not possible to express options exceeding the number of the expression bits 10 in the case of one-hot expression. For example, since the calculation model 100 illustrated in FIG. 2 has five expression bits 10, the calculation model 100 can express only five options.

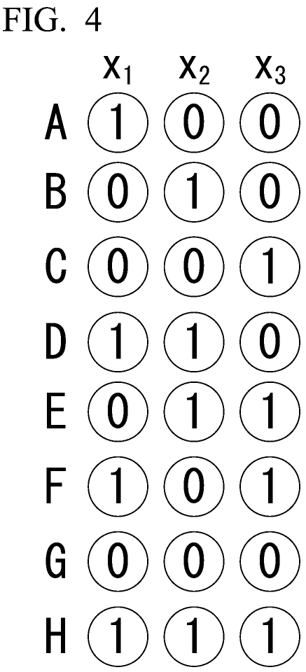

FIG. 4 illustrates an example of a case in which options are displayed in the binary expression. A to H in FIG. 4 are options in the combinatorial optimization problem.

The binary expression is a method of expressing N types of information in binary numbers. In the case of the binary expression, a plurality of bits are allowed to be “1” at the same time. In FIG. 4, the option A is assigned to (1, 0, 0), the option B is assigned to (0, 1, 0), the option C is assigned to (0, 0, 1), the option D is assigned to (1, 1, 0), the option E is assigned to (0, 1, 1), the option F is assigned to (1, 0, 1), the option G is assigned to (0, 0, 0), and the option H is assigned to (1, 1, 1).

For example, since the calculation model 100 illustrated in FIG. 2 has five expression bits 10, it is possible to express 25 options using the binary expression.

The binary expression has an advantage that a plurality of states can be expressed with a small number of bits. On the other hand, when one of the bits is rewritten due to noise or the like, the binary expression expresses another state. For example, in the option A in FIG. 4, when x₁ is incorrectly recognized as “0” instead of “1” due to noise, the option G is expressed. Therefore, the binary expression requires, particularly, measures against the noise.

The first surplus bit 21 is coupled to the expression bit 10. The variables y₁₁ to y₅₁ of the first surplus bits 21 have a certain rule with respect to the variables x₁ to x₅ of the expression bits 10 to which the first surplus bits 21 are coupled. The certain rule can be incorporated into the energy function by setting the forcing force F between the expression bit 10 and the first surplus bit 21. For example, the variables y₁₁ to y₅₁ of the first surplus bits 21 have the same values as the variables x₁ to x₅ of the expression bits 10 to which the first surplus bits 21 are coupled.

The second surplus bit 22 is coupled to the expression bit 10. for example. The variables y₁₂ to y₅₂ of the second surplus bits 22 have a certain rule with respect to the variables x₁ to x₅ of the expression bits 10 to which the second surplus bits 22 are coupled. The certain rule can be incorporated into the energy function by setting the forcing force F between the expression bit 10 and the second surplus bit 22. For example, the variables y₁₂ to y₅₂ of the second surplus bits 22 have the same values as the variables x₁ to x₅ of the expression bits 10 to which the second surplus bits 22 are coupled.

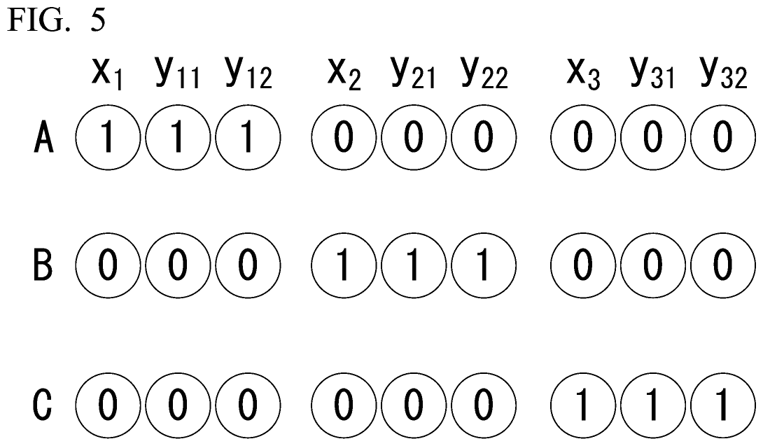

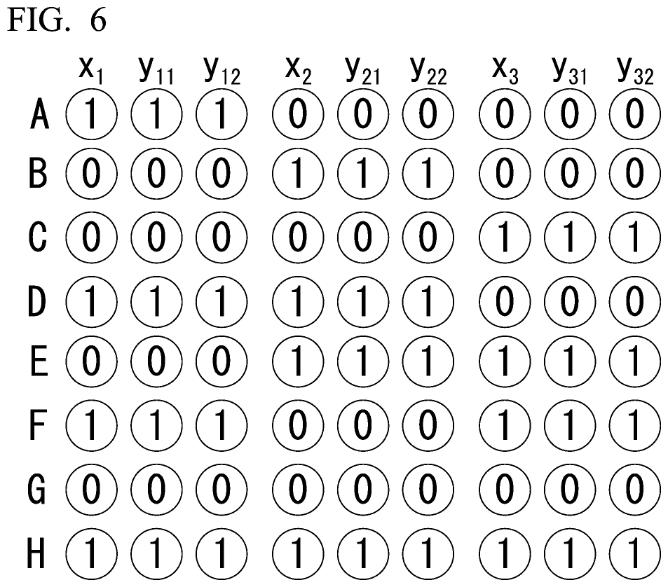

FIG. 5 illustrates an example of a case in which options, including the first surplus bits 21 and the second surplus bits 22, are displayed in the case of the one-hot expression illustrated in FIG. 3. Further, FIG. 6 illustrates an example of a case in which options, including the first surplus bits 21 and the second surplus bits 22, are displayed in the case of the binary expression illustrated in FIG. 4.

The calculation model 100 according to the present embodiment can perform error detection and error correction using the first surplus bits 21 and the second surplus bits 22. For example, bit inversion such as recognition of a bit as “0” instead of “1” is an example of an error. An error occurs when an unintended quantum transitions, noise, or the like occurs in a quantum annealing machine. Hereinafter, an information processing method using the calculation model according to the present embodiment will be described.

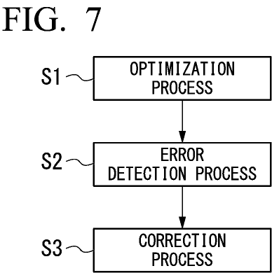

FIG. 7 is a process flow of the information processing method according to the present embodiment. The information processing method according to the present embodiment includes, for example, an optimization process S1, an error detection process S2, and a correction process S3.

In the optimization process S1, computing for solving the optimization problem using the calculation model is performed. For example, options of the optimization problem are applied to the energy function (cost function) described above. For example, the input variables qᵢ and qⱼ of the energy function described above correspond to the variables x₁ to x₅, y₁₁ to y₅₁, and y₁₂ to y₅₂ of the expression bit 10, the first surplus bit 21, and the second surplus bit 22. Further, since the interaction parameter Qᵢⱼ is set between the expression bit 10 and the first surplus bit 21, the certain rule can be assigned between the expression bit 10 and the first surplus bit 21. Similarly, since the interaction parameter Qᵢⱼ is set between the expression bit 10 and the second surplus bit 22, the certain rule can be assigned between the expression bit 10 and the second surplus bit 22.

The error detection process S2 is performed, for example, after the optimization process S1.

In the error detection process S2, the values of the variables x₁ to x₅ of the expression bits 10 are compared with the values of the variables y₁₁ to y₅₁ of the first surplus bits 21 coupled to the expression bits 10.

The values of the variables x₁ to x₅ of the expression bits 10 and the values of the variables y_{11 to} y₅₁ of the first surplus bits 21 coupled to the expression bit 10 have a relationship according to the certain rule assigned between the expression bit 10 and the first surplus bit 21 unless bit inversion due to an error occurs. For example, in the case of FIGS. 5 and 6, a rule that the variables y₁₁ to y₅₁ of the first surplus bits 21 and the variables x₁ to x₅ of the expression bits 10 to which the first surplus bits 21 are coupled have the same value is assigned. Therefore, when the variable x₁ of the expression bit 10 is “1”, the variable y₁₁ of the first surplus bit 21 is “1”. and when the variable x₁ of the expression bit 10 is “0”, the variable y₁₁ of the first surplus bit 21 is “0”.

On the other hand, when the bit inversion due to the error occurs, the expression bit 10 and the first surplus bit 21 coupled to the expression bit 10 do not satisfy the assigned certain rule. For example. in the case of FIGS. 5 and 6, the variables y₁₁ to y₅₁ of the first surplus bits 21 and the variables x₁ to x₅ of the expression bits 10 to which the first surplus bits 21 are coupled do not indicate the same value. For example, when the variable x₁ of the expression bit 10 is incorrectly recognized as “0” instead of “1”, the variable y₁₁ of the first surplus bit 21 becomes “1” even though the variable x₁ of the expression bit 10 is “0”.

In other words. a determination can be made that no error occurs when the expression bit 10 and the first surplus bit 21 coupled to the expression bit 10 satisfy the certain rule, and a determination can be made that an error occurs when the expression bit 10 and the first surplus bit 21 do not satisfy the certain rule.

Next, the correction process S3 is performed. The correction process S3 includes an error part specifying process and a bit inversion process.

An error determined in the error detection process S2 may be caused by bit inversion of the expression bit 10, or may be caused by bit inversion of the first surplus bit 21. In the error part specifying process, a cause is specified.

In the error part specifying process, the values of the variables x₁ to x₅ of the expression bits 10 determined to have an error, the values of the variables y₁₁ to y₅₁ of the first surplus bits 21 coupled to the expression bits 10, and the values of the variables y₁₂ to y₅₂ of the second surplus bits 22 coupled to the expression bits 10 are compared with each other.

For example, when x₁ of the option A in FIGS. 5 and 6 is bit-inverted, (x1, y₁₁, y₁₂)=(0, 1, 1). Since bit inversion is performed bit by bit, only a bit with an error is inverted, and the other bits are not inverted. For example, when a rule that three values match is assigned between these, the inverted bit can be specified by majority vote.

In the bit inversion process, a bit specified as a cause of the error is inverted and returned to an appropriate value. For example, in the above-described case, x₁ of (x₁, y₁₁, y₁₂)=(0, 1, 1) is inverted and returned to (x₁, y₁₁, y₁₂)=(1, 1, 1).

The optimization process S1 is executed, for example, by an information processing device (Ising machine) specialized in calculation of the Ising model or QUBO. For example, a machine such as a quantum annealing machine (D-wave, NEC), a coherent Ising machine (NTT), a simulated branching machine (Toshiba), a digital annealer (Fujitsu), and a CMOS annealer (Hitachi) is an example of the information processing device.

The error detection process S2 and the correction process S3 are executed by using a versatile general-purpose information processing device. For example, machine such as a personal computer, a supercomputer, or a microcomputer is an example of the general-purpose information processing device. Between the optimization process $1 and the error detection process S2, the Ising machine sends the values of the expression bits and the surplus bits obtained in the optimization process SI to the general-purpose information processing device, and the general-purpose information processing device executes the error detection process S2 and subsequent processes using the values of the expression bits and the surplus bits sent from the Ising machine.

Further, the optimization process SI may be executed by the general-purpose information processing device.

The information processing device (annealing machine) may be a quantum gate type computer. For example, when a Quantum Approximate Optimization Algorithm (QAQA) is used, the Ising model or the QUBO can be calculated with the quantum gate type computer.

The information processing device performs the information processing on the basis of an optimization program.

The optimization program performs the optimization process S1. A detection program performs the error detection process S2. A correction program performs a correction process S3.

A calculation program and an information processing device of the present embodiment can detect an error using the first surplus bits 21, correct the error using the second surplus bits 22, and obtain an appropriate optimal solution.

Although the embodiments of the present invention have been described above in detail with reference to the drawings, the respective configurations, combinations thereof, and the like in the respective embodiments are merely examples, and additions, omissions, substitutions, and other changes of configurations can be made without departing from the spirit of the present invention.

For example, in the embodiment, the rule that the values match is assigned between the expression bit 10, the first surplus bit 21, and the second surplus bit 22, but a rule to be assigned between these bits is not limited to such a rule.

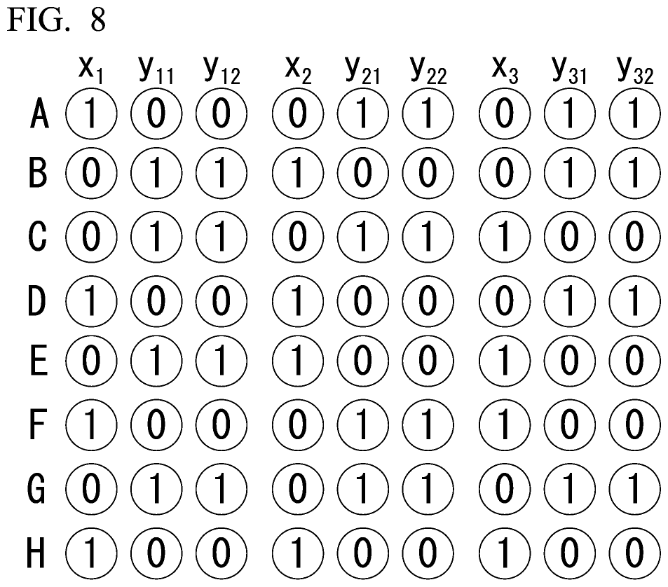

FIG. 8 illustrates another example in which options, including the first surplus bits and the second surplus bits, are displayed in the case of the binary expression illustrated in FIG. 4. In FIG. 8, a rule that the value of the expression bit 10 is different from the values of the first surplus bit 21 and the second surplus bit 22 is assigned.

In this case, a determination is made that an error has occurred when the variables y₁₁ to y₅₁ of the first surplus bits 21 match the variables x₁ to x₅ of the expression bits 10 to which the first surplus bits 21 are coupled, and a determination is made that no error has occurred when the variables do not match. Furthermore, when the variables y₁₁ to y₅₁ of the first surplus bits 21 match the variables y₁₂ to y₅₂ of the second surplus bits 22, a determination can be made that an error has occurred in the expression bit 10, and a location where the error has occurred can be specified.

Further, a rule that the values match between the expression bit 10 and the first surplus bit 21 may be assigned, and a rule that the values do not match between the expression bit 10 and the second surplus bit 22 may be assigned. Further, an opposite rule may be assigned between the bits.

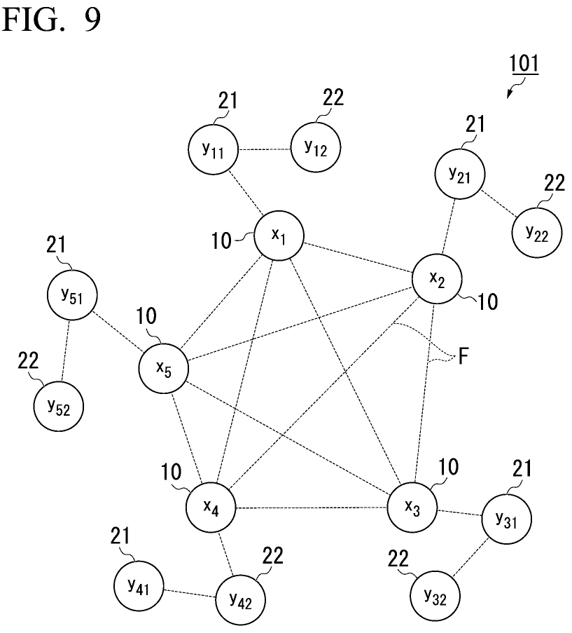

Further, although a case in which each of the first surplus bit 21 and the second surplus bit 22 is coupled to the expression bit 10 has been shown in FIG. 2, the second surplus bit 22 is coupled to the first surplus bit 21. A calculation model 101 illustrated in FIG. 9 is a modification example of the calculation model according to the present embodiment.

The second surplus bit 22 illustrated in FIG. 9 is coupled to the first surplus bit 21, for example. The variables y₁₂ to y₅₂ of the second surplus bits 22 have the certain rule with the variables y₁₁ to y₅₁ of the first surplus bits 21 to which the second surplus bits 22 are coupled. The certain rule can be incorporated into the energy function by setting the forcing force F between the first surplus bit 21 and the second surplus bit 22.

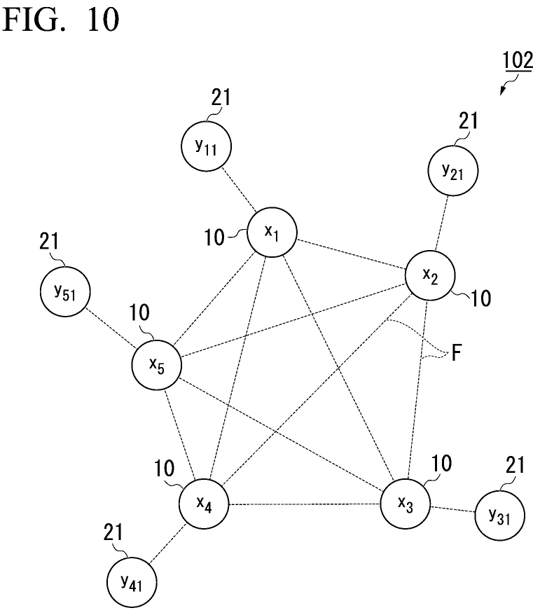

Furthermore, as illustrated in FIG. 10, the calculation model 102 may not have the second surplus bits 22. The calculation model 102 illustrated in FIG. 10 is a modification example of the calculation model according to the present embodiment. Since the calculation model 102 has the first surplus bit 21, it is possible to perform error detection. The calculation model 102 cannot perform the error correction, and the calculation model 102 may not have a function of correcting an error when there is a rule that the error correction is performed by other means or computing is initialized in a case in which an error has been detected.

Characteristic configurations of the embodiments and modification examples can be combined appropriately.

### REFERENCE SIGNS LIST

10: Expression bit

21: First surplus bit

22: Second surplus bit

100, 101, 102: Calculation model

S1: Optimization process

S2: Error detection process

S3: Correction process

S4: Re-computing process

x₁ to x₅, y₁₁ to y₅₁, and y₁₂ to y₅₂: Variable

What is claimed is:

1. A calculation model applicable to an Ising model or QUBO, the calculation model comprising:
a plurality of expression bits and a first surplus bit, wherein
each of the plurality of expression bits is a binary variable,
the plurality of expression bits indicate options in a combinatorial optimization problem, and
the first surplus bit is coupled to any one of the plurality of expression bits.

2. The calculation model according to claim 1, comprising:
a plurality of the first surplus bits, wherein
each of the first surplus bits is coupled to any one of the plurality of expression bits.

3. The calculation model according to claim 1, further comprising:
a second surplus bit coupled to an expression bit coupled to the first surplus bit or the first surplus bit.

4. The calculation model according to claim 1, wherein the plurality of expression bits express the options in a one-hot expression.

5. The calculation model according to claim 1, wherein the plurality of expression bits express the options in a binary expression.

6. The calculation model according to claim 1, wherein the Ising model or the QUBO is executed by a quantum annealing machine.

7. An information processing method using the calculation model according to claim 1, the information processing method comprising:
comparing the first surplus bit with an expression bit coupled to the first surplus bit to detect an error.

8. The information processing method using the calculation model according to claim 3, comprising:
comparing the first surplus bit with the expression bit coupled to the first surplus bit to detect an error; and
correcting the error on the basis of values of the first surplus bit, the second surplus bit, and the expression bit.

9. A storage medium that stores a calculation program, the calculation program comprising:
a computing program configured to perform computing using the calculation model according to claim 1; and
a detection program configured to compare the first surplus bit with the expression bit coupled to the first surplus bit to detect an error.

10. A storage medium that stores a calculation program, the calculation program comprising:
a computing program configured to perform computing using the calculation model according to claim 3;
a detection program configured to compare the first surplus bit with the expression bit coupled to the first surplus bit to detect an error, and
a correction program configured to correct the error on the basis of values of the first surplus bit, the second surplus bit, and the expression bit.

11. An information processing device comprising the calculation program according to claim 9.

12. An information processing device comprising the calculation program according to claim 10.
